(19) United States
(12) Patent Application Publication
(10) Pub. No.: US 2006/0046224 A1
(43) Pub. Date: Mar. 2, 2006

(54) Molar appliance for an orthodontic brace

(75) Inventors: Anoop Sondhi, Carmel, IN (US); John S. Kelly, Arcadia, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/930,203

(22) Filed: Aug. 31, 2004

(51) Int. Cl. A61C 3/00

(52) U.S. Cl. 433/17

(57) ABSTRACT

An orthodontic appliance in one aspect for a maxillary second molar tooth is pre-adjusted to provide a distal offset that is in the range of about 6 degrees to about 10 degrees and a torque that is greater in a negative direction than about −15 degrees. In another aspect, an orthodontic appliance for a molar tooth has a buccal wall with a recess, and a notch is located in the recess for facilitating positioning the appliance on the tooth.

### BACKGROUND OF THE INVENTION

1. Field of the Invention

This invention relates to an appliance that is used during the course of orthodontic treatment to correct malocclusions. More particularly, the present invention is directed to an orthodontic appliance that is especially adapted for use with a patient's upper second molar tooth.

2. Description of the Related Art

Orthodontic therapy is a specialized type of treatment within the field of dentistry, and involves movement of malpositioned teeth to orthodontically correct locations. Orthodontic treatment typically enhances the aesthetic appearance of the teeth, particularly in areas near the front of the oral cavity. Orthodontic treatment can also improve the patient's occlusion, such that the teeth function better with each other during mastication.

Many types of orthodontic treatment programs involve the use of a set of tiny appliances and archwires that are commonly known collectively as “braces”. During such treatment programs, small slotted appliances known as brackets are fixed to the patient's anterior, cuspid and bicuspid teeth, and an archwire is inserted into the slot of each bracket. The archwire forms a track to guide movement of the teeth to orthodontically correct locations.

End sections of orthodontic archwires are typically captured in tiny appliances known as buccal tubes. The buccal tubes are fixed to the patient's molar teeth. Molar teeth have relatively large roots and consequently provide good anchorage for various forces that may be exerted on the dental arch during orthodontic treatment.

In the past, orthodontic treatment was often carried out by forming bends, twists and loops in the archwire as needed for each tooth. The practitioner would then rely on the inherent resiliency of the archwire to urge the teeth to desired locations and proper angular orientations. However, the practice of custom-forming an archwire according to the particular malocclusion of the patient represents a significant expenditure of the practitioner's time. Moreover, considerable skill is needed to bend an archwire to an exact configuration sufficient to guide the teeth to desired positions.

In more recent times, the use of pre-adjusted orthodontic appliances has enjoyed widespread popularity. Pre-adjusted appliances are constructed with archwire slots or passages that extend at a certain, pre-selected orientation relative to the base of the appliance. This orientation varies from tooth to tooth, and is selected to help ensure that each tooth is in a desired orientation when the archwire slots or passages of all of the appliances extend in a common plane that is parallel to the occlusal plane at the conclusion of treatment. As a result, the use of a custom-formed archwire with bends, twists and the like can be avoided.

Over the years, a variety of orthodontic brackets and buccal tubes have been available, with varying degrees of torque and angulation (as described below) built into the appliance. The choice of appliance is often based on the personal preferences of the practitioner. These preferences may be governed by the practitioner's philosophy on occlusal function and its potential impact on temporomandibular disorders.

### SUMMARY OF THE INVENTION

The present invention is directed toward a pre-adjusted orthodontic appliance for a maxillary second molar tooth. It has been found that many second molar teeth erupt with an orientation such that the crown portion of the tooth is unduly inclined in a buccal direction and consequently the roots of the tooth are unduly inclined in a lingual direction. I have found, in general, that many of the prior art pre-adjusted appliances for the maxillary second molar teeth are constructed with inadequate torque, with the consequent undesirable result of an undue extension of the lingual cusps of the tooth into the occlusal plane. The molar appliance of the present invention not only improves the orientation of the maxillary second molar tooth, but also serves to improve occlusion of other teeth as well.

In more detail, the present invention in one aspect is directed to an orthodontic appliance for a maxillary second molar tooth. The appliance comprises a base having a tooth-facing surface for coupling to a maxillary second molar tooth, and a body extending outwardly from the base. The appliance also includes an elongated archwire passage extending across the body in a generally mesial-distal direction. The passage has a generally rectangular configuration in reference planes perpendicular to its longitudinal axis. The passage is oriented relative to the tooth-facing surface of the base with a distal offset that is in the range of about 6 degrees to about 10 degrees and a torque that is greater in a negative direction than about −15 degrees.

Another aspect of the present invention is directed toward an orthodontic brace. The brace comprises a set of orthodontic appliances for connection to respective teeth of a dental arch. The brace also comprises an archwire connected to the appliances. The set of appliances includes at least one maxillary second molar appliance that comprises a base having a tooth-facing surface for coupling to a maxillary second molar tooth, a body extending outwardly from the base, and an elongated archwire passage extending across the body. The archwire is received in the archwire passage, and the passage has a generally rectangular configuration in reference planes perpendicular to its longitudinal axis. The passage is oriented relative to the tooth-facing surface of the base with a distal offset that is in the range of about 6 degrees to about 10 degrees and a torque that is greater in a negative direction than about −15 degrees.

An additional aspect of the present invention is directed toward an orthodontic appliance for a molar tooth. In this aspect, the appliance comprises a base having a tooth-facing surface for coupling to a molar tooth, a body extending outwardly from the base, and an elongated archwire passage that extends across the body in a generally mesial-distal direction. The body includes a buccal wall portion that extends across the passage. The buccal wall portion includes a recess, and the buccal wall portion also includes a notch that is located at least partially in the recess.

Further aspects of the invention are set out in the detailed description that follows and are illustrated in the accompanying drawings.

### BRIEF DESCRIPTION OF THE DRAWINGS

FIG. 1 is a front elevational view showing the upper teeth of an exemplary patient undergoing orthodontic treatment, wherein orthodontic appliances are fixed to the teeth and an archwire has been connected to the appliances;

FIG. 2 is a bottom or occlusal view of the teeth, appliances and archwire illustrated in FIG. 1;

FIG. 3 is an enlarged perspective view of one of the appliances that is connected to one of the second molar teeth shown in FIGS. 1 and 2, looking at the appliance in a direction toward its mesial, buccal and occlusal sides;

FIG. 4 is an end elevational view of the appliance shown in FIG. 3, looking at the appliance toward its mesial side;

FIG. 5 is an end elevational view of the appliance shown in FIGS. 3 and 4, looking at the appliance toward its distal side;

FIG. 6 is a bottom view of the appliance shown in FIGS. 3-5, looking at the appliance toward its occlusal side;

FIG. 7 is a front elevational view of the appliance shown in FIGS. 3-6, looking at the appliance toward its buccal side;

FIG. 8 is a top view of the appliance shown in FIGS. 3-7, looking at the appliance toward its gingival side;

FIG. 9 is a cross-sectional view taken across lines 9-9 of FIG. 5; and

FIG. 10 is a cross-sectional view taken across lines 10-10 of FIG. 6.

### DEFINITIONS

“Mesial” means in a direction toward the center of the patient's curved dental arch.

“Distal” means in a direction away from the center of the patient's curved dental arch.

“Occlusal” means in a direction toward the outer tips of the patient's teeth.

“Gingival” means in a direction toward the patient's gums or gingiva.

“Buccal” means in a direction toward the patient's cheeks.

“Lingual” means in a direction toward the patient's tongue.

### DETAILED DESCRIPTION OF THE PREFERRED EMBODIMENTS

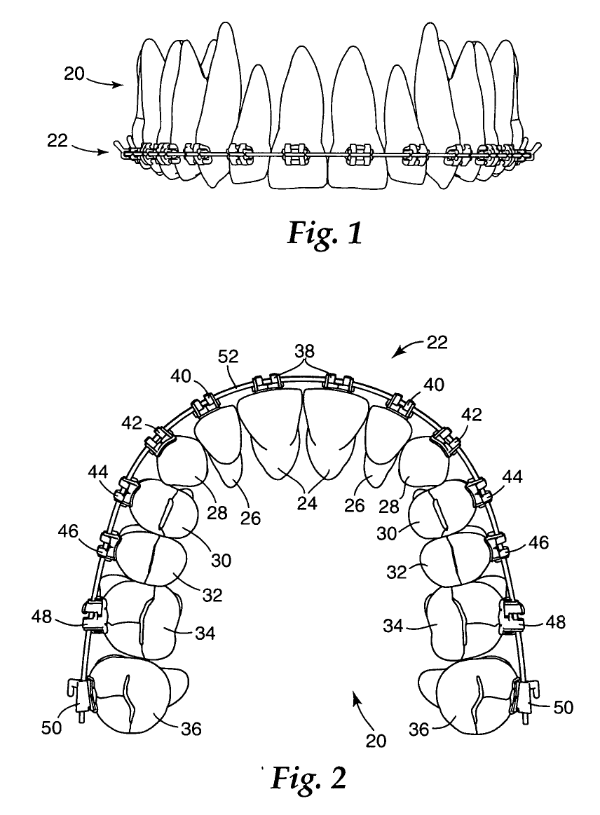

FIG. 1 illustrates an example of an upper dental arch 20 of an orthodontic patient that is undergoing orthodontic therapy. An orthodontic brace, broadly designated by the numeral 22, is connected to the teeth of the upper dental arch 20. The brace 22 includes a set of appliances along with an archwire that is received in the appliances, as will be described in more detail below.

FIG. 2 is an enlarged view of the upper dental arch 20 along with the brace 22, looking in an upwardly direction toward the outer or occlusal tips of the teeth. The upper dental arch 22 includes a left quadrant and a right quadrant, each of which has a central incisor tooth 24, a lateral incisor tooth 26, a cuspid tooth 28, a first bicuspid tooth 30, and a second bicuspid tooth 32. In addition, each of the left and right quadrants includes a first molar tooth 34 and a second molar tooth 36.

The illustration of the upper dental arch 22 shown in FIGS. 1 and 2 is only one example of dentition, and many variations are possible. For example, the patient may lack one or more of the illustrated teeth, as may occur in adolescent patients when some of the permanent teeth have not yet erupted. Alternatively, one or more teeth may have been removed prior to orthodontic treatment in order to reduce crowding, especially in instances where the overall size of the dental arch is relatively small.

The upper brace 22 includes a set of appliances that is connected to the teeth of the upper arch 20. In particular, the brace 22 in each of the left and right quadrants includes a central incisor appliance 38 that is coupled to the central incisor tooth 24, a lateral incisor appliance 40 that is connected to the lateral incisor tooth 26, and a cuspid appliance 42 that is connected to the cuspid tooth 28. The brace 22 also includes in each quadrant a first bicuspid appliance 44 that is coupled to the first bicuspid tooth 30, a second bicuspid appliance 46 that is connected to the second bicuspid tooth 32, a first molar appliance 48 that is connected to the first molar tooth 34 and a second molar appliance 50 that is connected to the second molar tooth 36.

The brace 22 further includes an archwire 52 that is made of a resilient material. Suitable materials include, for example, metallic materials such as alloys of nitinol and stainless steel. In plan view, the archwire 52 has an overall, generally “U”-shaped configuration that extends along both of the quadrants.

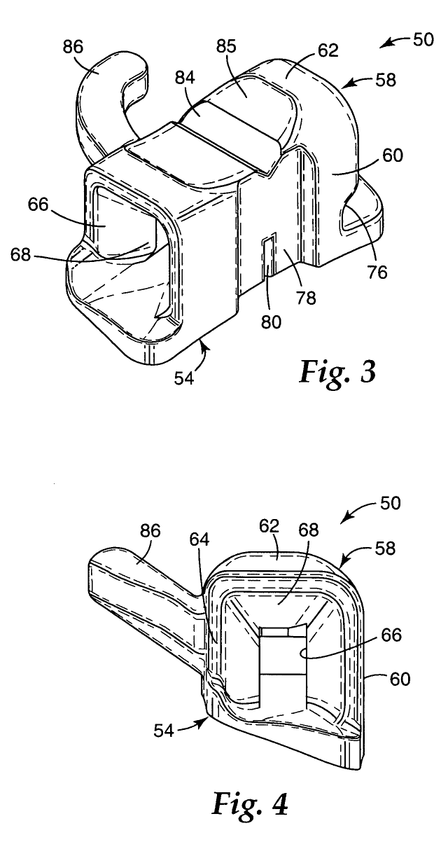

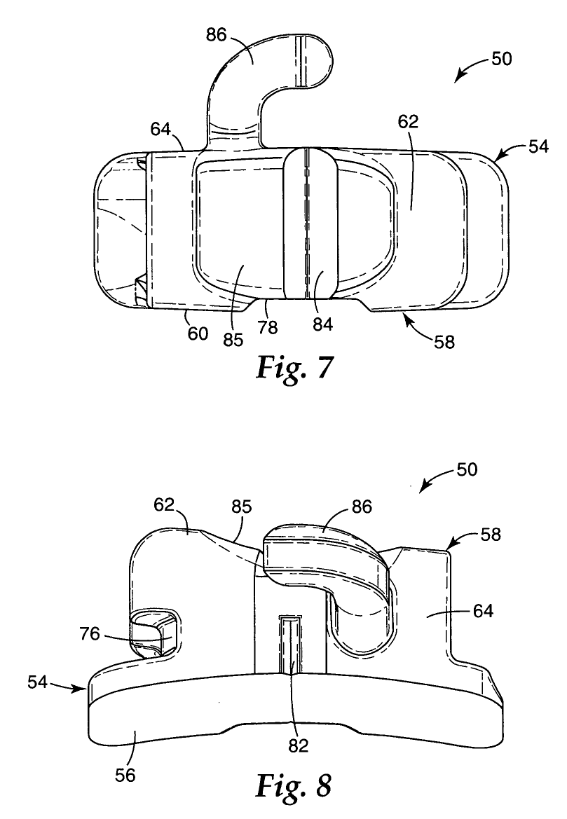

The second molar appliance 50 or buccal tube appliance is shown in more detail in FIGS. 3-10. The appliance 50 has a base 54 with an outer, tooth-facing surface 56 (see FIG. 8) for coupling to the outer enamel surface of the second molar tooth 36.

In the embodiment illustrated in the drawings, the base surface 56 is adapted for bonding the appliance 50 directly to the enamel of the second molar tooth 36 by use of an adhesive. Preferably, the surface 56 has a compound concave contour that matches the compound convex contour of the tooth surface. Optionally, the surface 56 may be provided with grooves, particles, recesses, undercuts, a chemical bond enhancement material or any other material or structure or any combination of the foregoing that facilitates bonding the appliance 50 directly to the tooth surface.

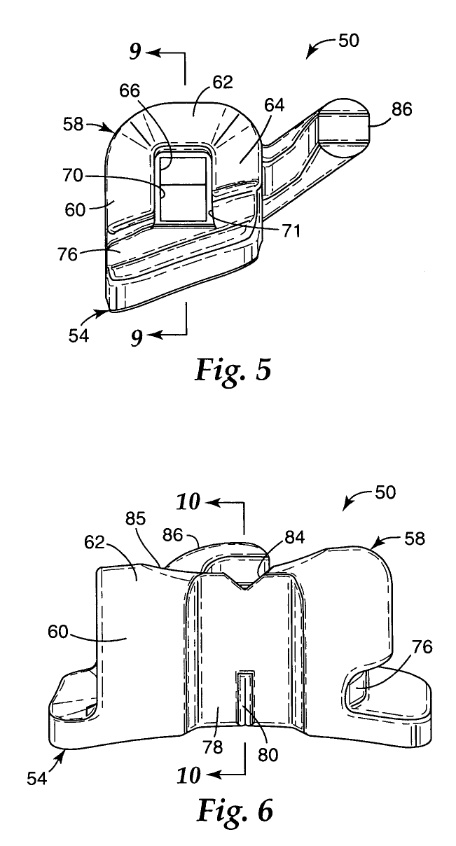

A body 58 extends outwardly from the base 54 in a generally buccal direction. The body 58 includes an occlusal wall portion 60, a buccal wall portion 62 and a gingival wall portion 64. In end view, and as shown in FIGS. 4 and 5, the wall portions 60, 62, 64 together present a generally “U”-shaped configuration. The distal end regions of the wall portions 60, 62, 64 are curved along relatively broad arcs in order to reduce irritation of adjacent tissue in the oral cavity.

An elongated archwire passage 66 extends across and through the body 58 in a generally mesial-distal direction. The passage 66 includes a mesial section 68 that is adjacent chamfered areas of the wall portions 60, 62, 64 to present a funneled entry. The funnel-shaped mesial section 68 facilitates insertion of the archwire 52 in the passage 66.

The archwire passage 66 also includes a distal section 70 that has a generally rectangular configuration in cross-section as shown for example in FIG. 5. The distal section 70 extends from the distal side of the mesial archwire passage section 68 to the distal end of the wall portions 60, 62, 64.

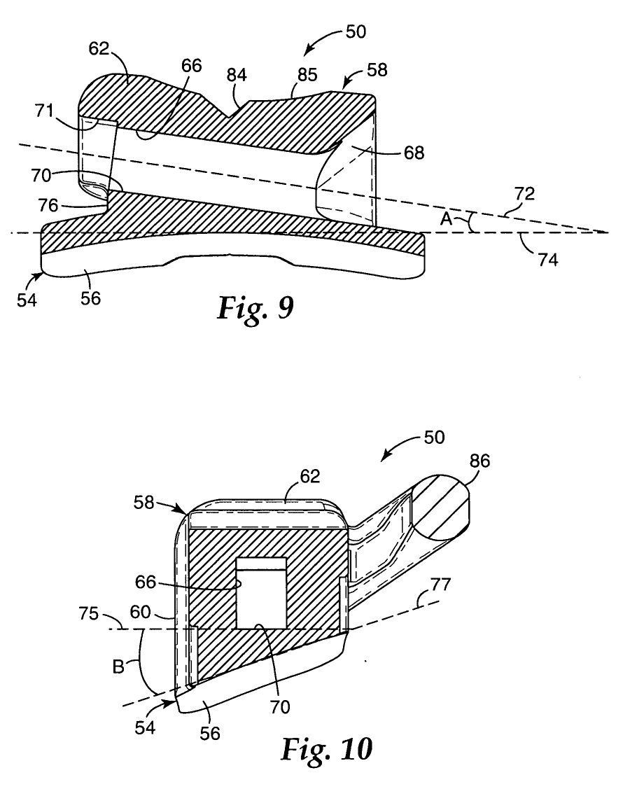

The distal section 70 includes a distal relief portion 71 that is shown in FIGS. 5 and 9. The distal relief portion 71 has a larger cross-sectional configuration than the remaining portion of the distal section 70, and serves to cover the end of the archwire 52 during treatment. As a consequence, the end of the archwire 52 is less likely to extend past the appliance 50 and contact adjacent oral tissue, so that tissue irritation and injury can be avoided.

The passage 66 has a central longitudinal axis that is located at a particular orientation relative to the tooth-facing surface 56 of the base 54. In particular, and with reference to FIG. 9, the longitudinal axis (designated 72) extends at a certain angle relative to a reference line 74. The reference line 74 is tangent to the base surface 56 at a point that is located in a lingual direction beneath the mesial-distal center and occlusal-gingival center of the archwire passage 66. This angle, known as the “offset”, is designated “A” in FIG. 9 and is preferably in the range of about 6 degrees to about 10 degrees and most preferably is about 8 degrees. Moreover, when the appliance 50 is correctly positioned on the tooth 36, the tangent point of the reference line 74 coincides with or is directly adjacent in a buccal direction the facial axis point, or “FA point”, of the tooth 36.

In addition, the appliance 50 is provided with a certain torque that is designated by the letter “B” in FIG. 10. The torque, or angle B, is equivalent to the angle between a reference plane 75 containing the lingual wall of the archwire passage 66 and a reference line 77 shown in FIG. 10. The reference line 77 extends in an occlusal-gingival direction and is tangent to the surface 56 at the above-mentioned point of tangency of the reference line 74. The torque is greater in a negative direction than about -15 degrees, more preferably greater in a negative direction than about −17 degrees and most preferably is about −19 degrees.

Preferably, and as depicted in FIGS. 3, 5, 6 and 8, the appliance 50 includes a groove 76 for retaining a wire segment such as a tieback loop in place. The groove 76 extends along the distal end of the appliance 50 including notched portions of the distal sections of the occlusal wall portion 60 and the gingival wall portion 64. Further details regarding the groove 76 and possible methods of use are described in U.S. Pat. No. 6,733,285, which is incorporated by reference herein.

Preferably, the appliance 50 also includes a recess 78 that extends along the occlusal wall portion 60. Optionally, the recess 78 is provided with placement enhancement structure such as protrusions (including pins, posts, ridges and the like) or holes, pores or cavities. As an additional option, the placement enhancement structure may comprise a roughened surface, a knurled surface, or a surface that is provided with other types of patterns and/or cross-hatchings. Optionally, the placement enhancement structure may comprise any combination of the foregoing.

The placement enhancement structure facilitates gripping of the appliance by a hand instrument such as fine-tipped pliers or other tools used by the practitioner to grasp the body 58. The placement enhancement structure helps ensure that the appliance 50 will not unduly shift relative to the hand instrument when the practitioner is maneuvering the appliance 50 in the oral cavity and placing the appliance 50 on the tooth surface. Optionally, the tips of the hand instrument are also roughened or have protrusions.

Additional options and aspects of the placement enhancement structure are described in applicant's pending U.S. Patent Application entitled “ORTHODONTIC APPLIANCE WITH PLACEMENT ENHANCEMENT STRUCTURE”, Published Patent Application No. 2004/0121279, which is incorporated by reference herein.

Optionally, and as shown in FIGS. 3, 6 and 8, the appliance 50 includes two alignment marks 80, 82. The alignment mark 80 extends in the recess 78 of the occlusal wall portion 60, while the alignment mark 82 extends along the gingival wall portion 64. The alignment marks 80, 82 are useful for positioning the appliance 50 on the surface of the tooth 36 in such a manner that the marks 80, 82 are aligned with the longitudinal axis of the tooth 36 and the appliance 50 is properly located over the FA point of the tooth 36.

Additionally, the appliance 50 preferably includes a positioning notch 84 that is shown in FIGS. 3, 6 and 7. The positioning notch 84 has a generally “V”-shaped configuration in cross-sectional view and extends along the buccal wall portion 62 in a generally occlusal-gingival direction. The notch 84 is useful during a bonding procedure for shifting the appliance 50 to a precise location. For example, once the base surface 56 of the appliance 50 has been firmly embedded in the adhesive, the practitioner may elect to place the tip of a probe in the notch 84 and shift the appliance 50 slightly until the exact desired position is attained.

Preferably, the notch 84 is located in a recess 85 that extends along the outer surface of the buccal wall portion 62. Optionally, and as shown in the drawings, the recess 85 has an overall smoothly curved concave configuration, wherein the curve extends in an arc about a reference axis that extends in a generally occlusal-gingival direction. The notch 84 is located in the center and deepest portion of the recess 85 (i.e., the portion closest to the base 54).

The recess 85 provides a number of advantages. The recess 85 is useful for receiving the practitioner's fingertip during initial positioning and placement of the appliance 50. Furthermore, the curved, inclined wall portions defining the recess 85 are useful for guiding the tip of a probe into the notch 84 for additional positioning and shifting of the appliance 50 as may be desired. Moreover, the recess 85 serves to reduce the bulk of the body 58.

The appliance 50 also includes a hook 86 for optional attachment to a force module or other device. Preferably, the hook 86 is sufficiently flexible such that it can be bent to an alternative configuration by the practitioner using a hand instrument, and yet will remain fixed in its newly formed position during the course of treatment.

The appliance 50 may be made of any material that is suitable for use in the oral cavity and has sufficient strength to resist the stresses normally encountered during the course of orthodontic treatment. Examples of such materials include metallic materials including alloys of stainless steel and titanium. A particularly preferred appliance is made of stainless steel, such as series 17-4PH or 316L, using a metal injection molding technique.

The appliance 50 as illustrated in the accompanying drawings is adapted to be adhesively connected directly to the surface of the second molar tooth 36. However, other options for coupling the appliance 50 to the surface of the tooth 36 are also possible. For example, the appliance 50 could be fixed to an orthodontic band that is adapted to encircle the patient's second molar tooth 36. Suitable orthodontic bands include stainless steel bands, such as Victory Series brand bands and Unitek brand bands from 3M Unitek Corporation.

If the appliance 50 is constructed for fixed attachment to a band, the outer, tooth facing base surface 56 may be curved in only one direction to facilitate connection to the band. Specifically, the surface 56 could be curved in an arc in directions about an occlusal-gingival reference axis, but be flat instead of curved in directions about a mesial-distal reference axis. In this case, the reference line 77 used to determine torque in connection with FIG. 10 would coincide with the flat or straight direction of extension of the surface 56.

Other options are also possible. For example, the passage 66 need not be fully enclosed along its gingival, occlusal and buccal sides. Optionally, a latch (such as a latch comprising self-releasing spring clips) may be provided to releasably retain the archwire 52 in place. Examples of such a passage and latch are described in Published U.S. Patent Application No. 2004/0086826, which is expressly incorporated by reference herein. In addition, the hook 86 may be omitted if desired.

Preferably, the appliances 38, 48 are also pre-adjusted according to the treatment philosophy of Dr. Richard McLaughlin, Dr. John Bennett and Dr. Hugo Trevisi. Table I sets out the approximate preferred torque and angulation values for the appliances 38-48. Optionally, any or all of the torque and/or angulation values in Table I may vary from the following values by plus or minus about 2 degrees, and more preferably by plus or minus about 1 degree.

TABLE I

| Appliance Type | Reference Numeral | Torque | Angulation |
|---|---|---|---|
| Central Incisor | 38 | 17 | 4 |
| Lateral Incisor | 40 | 10 | 8 |
| Cuspid | 42 | −7 | 8 |
| First Bicuspid | 44 | −7 | 0 |
| Second Bicuspid | 46 | −7 | 0 |
| First Molar | 48 | −20 | 0 |

The examples of the present invention described above are intended to exemplify various aspects and benefits of the invention. However, the invention should not be deemed limited to the specific embodiments set out above in detail, but instead only by a fair scope of the claims that follow along with their equivalents.

1. An orthodontic appliance for a maxillary second molar tooth comprising:
a base having a tooth-facing surface for coupling to the surface of a maxillary second molar tooth;
a body extending outwardly from the base; and
an elongated archwire passage extending across the body in a generally mesial-distal direction, wherein the passage has a generally rectangular configuration in reference planes perpendicular to its longitudinal axis, and wherein the passage is oriented relative to the tooth-facing surface of the base with a distal offset that is in the range of about 6 degrees to about 10 degrees and a torque that is greater in a negative direction than about −15 degrees.

2. The orthodontic appliance of claim 1 wherein the distal offset is about 8 degrees.

3. The orthodontic appliance of claim 1 wherein the torque is greater in a negative direction than about −17 degrees.

4. The orthodontic appliance of claim 1 wherein the torque is greater in a negative direction than about −19 degrees.

5. The orthodontic appliance according to claim 1 wherein the tooth-facing surface includes structure for adhesively bonding the appliance directly to the enamel surface of the tooth.

6. The orthodontic appliance according to claim 1 wherein the tooth-facing surface is connected to an orthodontic band.

7. The orthodontic appliance according to claim 1 wherein the archwire passage includes a distal relief section.

8. The orthodontic appliance according to claim 1 wherein the archwire passage includes a mesial section that is funneled.

9. The orthodontic appliance according to claim 1 wherein the body includes a buccal wall portion, and wherein the buccal wall portion includes a recess and a notch located at least partially in the recess.

10. The orthodontic appliance according to claim 9 wherein the recess has an overall curved configuration.

11. An orthodontic brace comprising:
a set of orthodontic appliances for connection to respective teeth of a dental arch; and
an archwire connected to the appliances, wherein the set of appliances include at least one maxillary second molar appliance comprising a base having a tooth-facing surface for coupling to the surface of a maxillary second molar tooth, a body extending outwardly from the base, and an elongated archwire passage extending across the body, wherein the archwire is received in the archwire passage, wherein the passage has a generally rectangular configuration in references planes perpendicular to its longitudinal axis, and wherein the passage is oriented relative to the tooth-facing surface of the base with a distal offset that is in the range of about 6 degrees to about 10 degrees and a torque that is greater in negative direction than about −15 degrees.

12. The orthodontic brace of claim 11 wherein the distal offset is about 8 degrees.

13. The orthodontic brace of claim 11 wherein the torque is greater in a negative direction than about −17 degrees.

14. The orthodontic brace of claim 11 wherein the torque is about −19 degrees.

15. The orthodontic brace of claim 11 wherein the tooth-facing surface includes structure for adhesively bonding the appliance directly to the enamel surface of the tooth.

16. The orthodontic brace of claim 11 wherein the tooth-facing surface is connected to an orthodontic band.

17. The orthodontic brace of claim 11 wherein the archwire passage includes a mesial section that is funneled.

18. The orthodontic appliance according to claim 11 wherein the body includes a buccal wall portion, and wherein the buccal wall portion includes a recess and a notch located at least partially in the recess.

19. The orthodontic appliance according to claim 18 wherein the recess has an overall curved configuration.

20. An orthodontic appliance for a molar tooth comprising:
a base having a tooth-facing surface for coupling to a molar tooth;
a body extending outwardly from the base; and
an elongated archwire passage extending across the body in a generally mesial-distal direction, wherein the body includes a buccal wall portion that extends across the passage, wherein the buccal wall portion includes a recess, and wherein the buccal wall portion also includes a notch that is located at least partially in the recess.

21. An orthodontic appliance according to claim 20, wherein the recess has an overall curved configuration.

22. An orthodontic appliance according to claim 20, wherein the passage extends through the body in a generally mesial-distal direction.

23. An orthodontic appliance according to claim 20, wherein the notch is elongated and has an overall generally “V”-shaped configuration in longitudinal cross-sectional view.

24. An orthodontic appliance according to claim 20 wherein the recess has an overall curved configuration and extends in an arc about a reference axis extending in a generally occlusal-gingival direction.

25. An orthodontic appliance according to claim 20 wherein the recess has a size sufficient to receive a fingertip of an orthodontic practitioner.

26. An orthodontic appliance according to claim 20 wherein the appliance is an appliance for a maxillary second molar tooth.
